(19) United States
(12) Patent Application Publication
(10) Pub. No.: US 2005/0236729 A1
(43) Pub. Date: Oct. 27, 2005

(54) Method and apparatus for vibrating melt in an injection molding machine using active material elements

(76) Inventor: Robin A. Arnott, Alliston (CA)

Correspondence Address: KATTEN MUCHIN ROSENMAN LLP, 525 WEST MONROE STREET, CHICAGO, IL, 60661-3693, US

(21) Appl. No.: 10/830,488

(22) Filed: Apr. 23, 2004

(51) Int. Cl. B29C 45/00; B29C 45/26

(52) U.S. Cl. 264/71; 264/443; 264/478; 264/328.1; 425/135

(57) ABSTRACT

Method and apparatus for applying vibration and/or oscillation to melt within an injection mold includes at least one stable surface within the mold, at least one movable surface within the mold, at least one active material element affixed to each stable surface, and adjacent to each movable surface. In use, a control means repeatedly energizes the at least one active material element, wherein the repeated energizing of the at least one active material element generates vibration and/or oscillation in the melt. In the method, at least one active material element is activated intermittently to move the at least one movable surface with respect to the at least one fixed surface. In the apparatus, a wiring conduit is coupled to the active material insert, and is configured to carry vibration signals to the at least one active material element.

### BACKGROUND OF THE INVENTION

1. Field of the Invention

The present invention relates to a method and apparatus in which active material elements are used in injection molding machine equipment in order to vibrate melt contained in a mold cavity or other area of an injection molding machine, thereby improving the quality of the molded article. “Active materials” are a family of shape altering materials such as piezoceramics, electrostrictors, magnetostrictors, shape memory alloys, and the like. The active material elements may also be used as sensors.

2. Related Art

Active materials are characterized as transducers that can convert one form of energy to another. For example, a piezo actuator (or motor) converts input electrical energy to mechanical energy causing a dimensional change in the element, whereas a piezo sensor (or generator) converts mechanical energy—a change in the dimensional shape of the element—into electrical energy. One example of a piezoceramic transducer is shown in U.S. Pat. No. 5,237,238 to Berghaus. One supplier of piezo actuators is Marco Systemanalyse und Entwicklung GmbH, Hans-Böckler-Str. 2, D-85221 Dachau, Germany, and their advertising literature and website illustrate such devices. Typically an application of 1,000 volt potential to a piezoceramic insert will cause it to “grow” approximately 0.0015″/inch (0.15%) in thickness. Another supplier, Mide Technology Corporation of Medford, Me., has a variety of active materials including magnetostrictors and shape memory alloys, and their advertising literature and website illustrate such devices, including material specifications and other published details.

Vibrating or oscillating molten plastic resin during its filling and curing time in an injection molding process is known to improve the properties of the finished molded article. U.S. Pat. No. 6,629,831 to Wei discloses using piezoelectric material in a nozzle to reduce the viscosity of the material flowing therein. U.S. Pat. No. 6,203,747 to Grunitz discloses a vibration element attached to a frequency generator for producing movement between an injection molding cylinder and the material conveyance unit to induce a vibration into the melt. U.S. Pat. No. 4,469,649 to Ibar discloses applying such a vibration to the melt in the injection unit of the molding machine. U.S. Pat. No. 5,192,555 to Arnott discloses applying such a vibration to the melt in a hot runner manifold of a mold. U.S. Pat. No. 5,439,371 to Sawaya discloses applying such a vibration locally inside the mold cavity to a specific portion of the molded article. Typically hydraulically actuated cylinders are used to induce the vibrations in these examples.

Thus, what is needed is a new technology capable of vibrating melt within the mold cavity with adjustable levels of vibration, and preferably with embedded sensors and closed loop control of the vibration.

### SUMMARY OF THE INVENTION

It is an advantage of the present invention to provide injection molding machine apparatus and method to overcome the problems noted above, and to advantageously provide an effective, efficient means for oscillating or vibrating melt within a mold cavity or other location in an injection molding machine.

According to a first aspect of the present invention, structure and/or steps are provided for generating vibration in melt within an injection mold, including the step of activating at least one active material element intermittently to move at least one movable surface in the mold with respect to at least one fixed surface in the mold.

According to a second aspect of the present invention, structure and/or steps are provided for an apparatus for oscillating melt in an injection mold, including at least one stable surface within the injection mold; at least one movable surface within the injection mold; at least one active material element affixed to each stable surface, and adjacent to each movable surface; and, in use, a control means for repeatedly energizing the at least one active material element, wherein the repeated energizing of the at least one active material element generates oscillation in the melt.

According to a third aspect of the present invention, structure and/or steps are provided for an apparatus for vibrating melted plastic in a mold cavity, including a cavity mold portion adjacent a cavity plate; a core mold portion adjacent a core plate; a mold cavity formed between the cavity mold portion and the core mold portion; at least one piezoceramic actuator disposed between one or both of (i) the core plate and the core mold portion, and (ii) the cavity plate and the cavity mold portion; and, in use, a controller connected to the at least one piezoceramic actuator.

### BRIEF DESCRIPTION OF THE DRAWINGS

Exemplary embodiments of the presently preferred features of the present invention will now be described with reference to the accompanying drawings in which:

FIG. 1 depicts a mold stack incorporating the present invention;

FIG. 2 depicts a core lock style preform molding stack incorporating the present invention in the rearward position; and

FIG. 3 depicts a core lock style preform molding stack incorporating the present invention in the forward cooling position.

### DETAILED DESCRIPTION OF THE PRESENTLY PREFERRED EXEMPLARY EMBODIMENTS

1. Introduction

The present invention will now be described with respect to several embodiments in which a plastic injection-molding machine is supplied with one or more active material elements which serve to actuate a mold core, causing agitation or vibration of the melt inside the injection molding machine mold cavity. However, the active material sensors and/or actuators may be placed in any location in the injection molding apparatus in which melt agitation may be desirable. Other applications for such active material elements are discussed in the related applications entitled (1) “Method and Apparatus for Countering Mold Deflection and Misalignment Using Active Material Elements”, (2) “Method and Apparatus for Adjustable Hot Runner Assembly Seals and Tip Height Using Active Material Elements”, (3) “Method and Apparatus for Assisting Ejection from an Injection Molding Machine using Active Material Elements”, (4) “Method and Apparatus for Controlling a Vent Gap with Active Material Elements”, (5) “Method and Apparatus for Mold Component Locking Using Active Material Elements”, (6) “Method and Apparatus for Injection Compression Molding Using Active Material Elements”, and (7) “Control System for Utilizing Active Material Elements in a Molding System”, all of which are being filed concurrently with the present application.

As discussed above, there is a need in the art for a method and apparatus for actuating a mold or machine portion, such as a core, using active material elements to impart vibration to the melt inside the mold cavity, hot runner or the machine's injection unit in order to improve the quality of the finished molded article. In the following description, piezoceramic inserts are described as the preferred active material. However, other materials from the active material family, such as magnetostrictors and shape memory alloys could also be used in accordance with the present invention. A list of possible alternate active materials and their characteristics is set forth below in Table 1, and any of these active materials could be used in accordance with the present invention:

TABLE 1
Comparison of Active Materials

| | Temperature | Nonlinearity | Structural | Cost/Vol. | Technical |
|---|---|---|---|---|---|
| Material | Range (° C.) | (Hysteresis) | Integrity | ($/cm3) | Maturity |
| Piezoceramic | −50-250 | 10% | Brittle | 200 | Commercial |
| PZT-5A | | | Ceramic | | |
| Piezo-single | — | <10% | Brittle | 32000 | Research |
| crystal TRS-A | | | Ceramic | | |
| Electrostrictor | 0-40 | Quadratic <1% | Brittle | 800 | Commercial |
| PMN | | | Ceramic | | |
| Magnetostrictor | −20-100 | 2% | Brittle | 400 | Research |
| Terfenol-D | | | | | |
| Shape Memory | Temp. | High | OK | 2 | Commercial |
| Alloy Nitinol | Controlled | | | | |
| Magn. Activated | <40 | High | OK | 200 | Preliminary |
| SMA NiMnGa | | | | | Research |
| Piezopolymer | −70-135 | >10% | Good | 15* | Commercial |
| PVDF | | | | | |

(information derived from www.mide.com)

2. The Structure of the First Embodiment

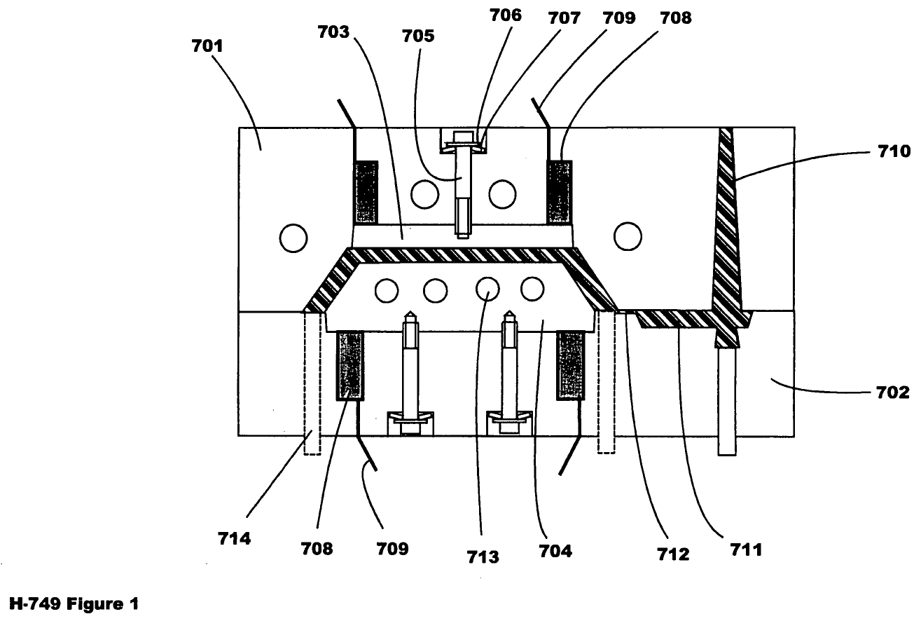

The first preferred embodiment of the present invention is shown in FIG. 1, which depicts a cold runner edge gated mold stack comprising a cavity block 701 and a core block 702, a movable cavity insert 703 and a movable core insert 704. The movable inserts are retained by bolts 705, fitted with washers 706, and spring washers 707, such that the spring washers 707 constantly urge the insert toward its respective recessed cutout in its respective block.

The movable cavity insert 703 and movable core insert 704 may be provided with piezoceramic devices 708 such that either or both of the inserts 703, 704 may be actuated to cause vibration of the melt within the mold cavity. The piezoceramic devices 708 are connected to a controller (not shown) by conduits 709.

The plastic is injected into the cavity via sprue 710, runner 711 and gate 712. Cooling channels 713 in the blocks and inserts cool the plastic so that it quickly solidifies into the molded shape. Ejector pins 714 are actuated after the mold has opened to cause the molded part to be ejected off the core in conventional manner. An alternative embodiment is to use only one movable insert in one half of the molding stack. A single insert may be sufficient to induce satisfactory vibratory oscillations in the melt in parts that have thinner wall sections. Use of a single insert system reduces the cost of the installation of the means for vibrating the melt in the mold.

According to the presently preferred embodiment of the present invention, an active material (e.g., piezoceramic) inserts 708 are located between the cavity block 701 and the movable cavity insert 703, and between the core block 702 and the movable core insert 704. The active material inserts 708 are preferably actuators driven by a controller (not shown) through wiring conduits 709, although wireless methods of control are also possible. It is also envisioned that the inserts 708 may be positioned in other locations within the mold assembly, so long as the location allows the actuation of the element to result in the injection mold components to be moved in a way that induces vibration in melt contained in the mold. For example, actuators may also be located at interfaces between the cavity block 701 and the core block 702, of a single actuator may be used instead of several actuators, as an alternative or in addition to the configuration shown in FIG. 1.

Piezoceramic inserts 708 are preferably single actuators that are annular and/or tubular in shape. According to a presently preferred embodiment, the actuator about 30.0 mm long and 25.0 mm in diameter, and increases in length by approximately 50 microns when a voltage of 1000 V is applied via conduits 709. However, use of multiple actuators and/or actuators having other shapes are contemplated as being within the scope of the invention, and the invention is therefore not to be limited to any particular configuration of the insert 708.

Preferably, one or more separate piezoceramic sensors may be provided adjacent the actuator 708 (or between any of the relevant surfaces described above) to detect pressure caused by presence of melt between the movable cavity insert 703 and the movable core insert 704, and/or to detect the degree of vibration being imparted to the melt by the actuation of elements 708. Preferably, the sensors provide sense signals to the controller (not shown). The piezo-electric elements used in accordance with the preferred embodiments of the present invention (i.e., the piezo-electric sensors and/or piezo-electric actuators) may comprise any of the devices manufactured by Marco Systemanalyse und Entwicklung GmbH. The piezo-electric sensor detects pressure and/or vibration applied to the melt using element 708 and transmits a corresponding sense signal through the wiring connections 709, thereby allowing the controller to effect closed loop feedback control. The piezo-electric actuator 708 will receive an actuation signal through the wiring connections 709, change dimensions in accordance with the actuation signal, and apply a corresponding force between the cavity block 701 and the movable cavity insert 703, and between the core block 702 and the movable core insert 704, thereby adjustably controlling the vibration imparted to the melt disposed between the movable cavity insert 703 and the movable core insert 704.

Note that the piezo-electric sensors may be provided to sense pressure at any desired position. Likewise, more than one piezo-electric actuator may be provided to form element 708, mounted serially or in tandem, in order to effect extended movement, angular movement, etc. Further, each piezo-electric actuator may be segmented into one or more arcuate, trapezoidal, rectangular, etc., shapes which may be separately controlled to provide varying vibratory forces at various locations between the surfaces. Additionally, piezo-electric actuators and/or actuator segments may be stacked in two or more layers to effect fine vibration control, as may be desired.

The wiring conduits 709 are coupled to any desirable form of controller or processing circuitry for reading the piezo-electric sensor signals and/or providing the actuating signals to the piezo-electric actuators. For example, one or more general-purpose computers, Application Specific Integrated Circuits (ASICs), Digital Signal Processors (DSPs), gate arrays, analog circuits, dedicated digital and/or analog processors, hard-wired circuits, etc., may control or sense the piezo-electric element 708 described herein. Instructions for controlling the one or more processors may be stored in any desirable computer-readable medium and/or data structure, such floppy diskettes, hard drives, CD-ROMs, RAMs, EEPROMs, magnetic media, optical media, magneto-optical media, etc.

Use of the element 708 according to the present embodiment also allows benefits that include the ability to adjust the vibration of melt within the mold more efficiently, thereby improving the quality of the molded articles being produced.

3. The process of the First Embodiment

According to the first preferred embodiment of the present invention, in operation, the movable cavity and core inserts 703 and 704 are moved by energizing piezoceramic devices 708, or the like, to cause the inserts to move away from the piezoceramic devices 708 and toward the mold cavity, thereby reducing the wall thickness of the part being molded adjacent the cavity and/or core insert being moved. The piezoceramic devices 708 are connected to a controller, not shown, via conduits 709 and can be energized intermittently, and alternately, at variable frequencies, so as to cause a vibratory oscillation in the molten resin. Such an induced vibration during and/or immediately after the injection of the resin into the cavity causes the finished molded part to have improved mechanical properties.

When the piezo-electric element 708 is used with a closed loop control configuration, the sensor element generates a signal in response to pressure and/or vibration between the movable cavity plate 703 and the movable core plate 704, and transmits the signal via conduit 709 to the controller (not shown). Based on the signals received from the sensor, the controller then generates appropriate actuation signals that are transmitted via conduit 709 to the actuator element 708, energizing it in accordance with the data received from the sensor to accomplish proper vibration of the melt contained between the movable cavity plate 703 and the movable core plate 704. For example, the controller may be programmed to cause the vibration to remain constant, or to increase and/or decrease the vibration according to a predetermined schedule, based on time, temperature, and/or number of cycles.

4. The Structure of the Second Embodiment

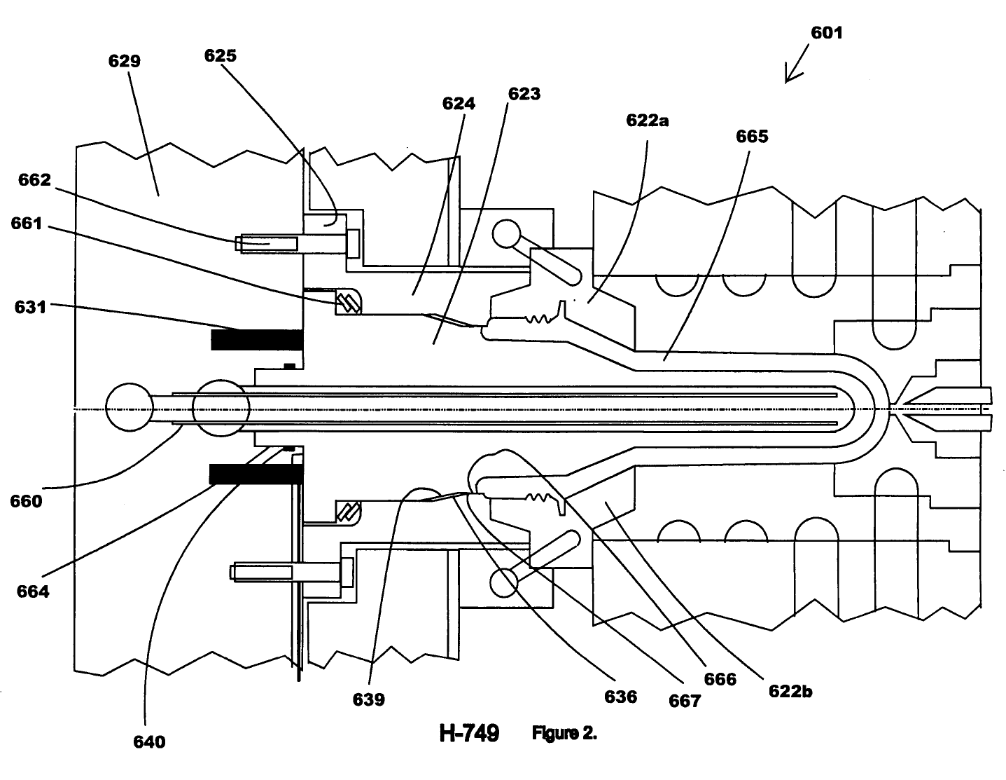

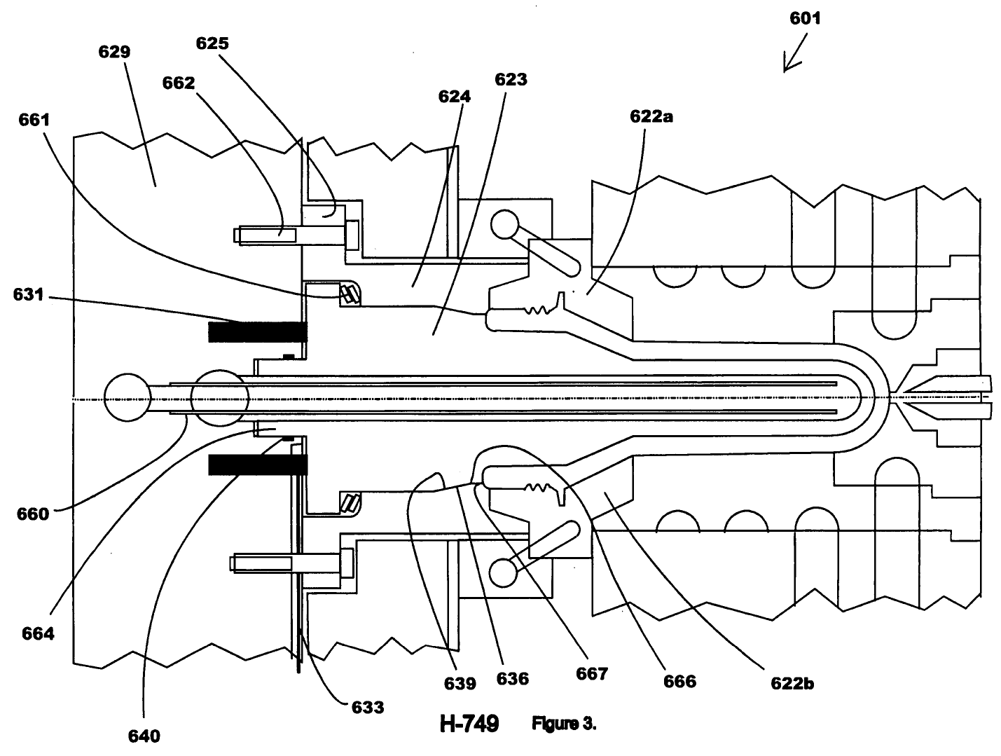

FIGS. 2 and 3 show a second preferred embodiment of the present invention. Preform molding stack 601 includes a core half that comprises a pair of neck rings 622a and 622b, lock ring 624, core 623, core cooling tube 660, core seal 640, core piezoceramic actuation sleeve 631, power supply connection 633, core spring set 661, and lock ring bolts 662. Lock ring 624 has a flange 625 through which bolts 662 fasten the lock ring to the core plate 629. Core 623 is located in the core plate 629 by spigot 664 and is urged against the core plate 629 by spring set 661 that may include one or more Belleville type spring washers.

Piezoceramic actuation sleeve 631 is positioned in the core plate 629, and when actuated, exerts a force against the base of the core 623, urging it away from the core plate 629, thereby compressing spring set 661. The core 623 has a tapered alignment surface 639 that contacts complementary surface 663 on the inner surface of lock ring 624 such that, when actuated, the core 623 is held forward against said taper as shown in FIG. 3. Piezoceramic actuation sleeve 631 provides sufficient force holding the core 623 in this position to ensure core stability and alignment during the curing phase of the molding cycle.

The core 623 also has a cylindrical portion 666 that contacts a complementary cylindrical portion 667 on the lock ring 623 to effect a sliding seal, thereby preventing the molding material from leaking through this cylindrical interface between surfaces 666 and 667 while permitting relative axial motion between the two surfaces.

Optionally, one or more separate piezoceramic sensors may be provided to detect pressure and/or vibration caused by melt between the core 623 and the cavity 665. These sensors may also be connected by conduits 633 to a controller. The piezo-electric elements used in accordance with the present invention (i.e., the piezo-electric sensors and/or piezo-electric actuators) may comprise any of the devices manufactured by Marco Systemanalyse und Entwicklung GmbH. The piezo-electric sensors can detect the pressure/vibration in the melt that is contained between the core 623 and the cavity 665 and transmit a corresponding sense signal through the conduits 633, thereby effecting closed loop feedback control. The piezo-electric actuators then receive actuation signals through the conduits 633, and apply corresponding forces. Note that piezo-electric sensors may be provided to sense pressure and/or vibration from any desired position. Likewise, more than one piezo-electric actuator may be provided in place of any single actuator described herein, and the actuators may be mounted serially or in tandem, in order to effect extended movement, angular movement, etc.

As mentioned above, one of the significant advantages of using the above-described active element inserts is that they provide improved vibration to the melt, resulting in higher quality molded articles, without requiring bulky or expensive vibration apparatus.

5. The process of the Second Embodiment

Similar to the process of the first embodiment, in operation, during the injection and/or hold phases of the molding cycle, the piezoceramic actuation sleeve 631 is cyclically actuated to cause the core 623 to move cyclically forward and back at a frequency selected to cause a vibratory effect in the melt as it fills the cavity 665. Vibrating the melt before it solidifies is known to improve the physical properties of the finished molded article and minimize the formation of weld lines and other flow induced imperfections that can cause blemishes in the appearance of the finished molded article. The piezoceramic actuation sleeve 631 is continuously activated after the period during which vibratory motion is induced in the melt, and before the melt has solidified, to ensure that the core 623 is held forward in its centered, aligned position so that the melt solidifies in the desired final shape. After the part has cooled sufficiently the mold is opened and the part is ejected conventionally.

In an alternate embodiment, piezoceramic elements acting as sensors (not shown) are used in combination with the actuating elements to provide a closed loop feedback configuration, as described above. The sensor elements generate signals in response to pressure and/or vibration of the melt present between the core 623 and the cavity 665, and transmit the signals via power supply connections 633 to a controller. Based on the signals received from the sensors, the controllers then generate other signals that are transmitted via connections 633 to the actuators, energizing them in accordance with the data received from the sensors to accomplish effective vibration of the melt contained within the mold.

6. Conclusion

Thus, what has been described is a method and apparatus for using active material elements in an injecting molding machine, separately and in combination, to effect useful improvements in vibrating the melt in an injection molding apparatus, preferably within the mold cavity, hot runner system, or injection unit of said injection molding apparatus.

Advantageous features according the present invention include: 1. An active material element insert used singly or in combination to generate vibration in melt within a mold cavity of an injection mold, within a hot runner system, or within an injection unit of an injection molding machine; 2. Melt vibrating apparatus using a closed loop controlled force generating unit acting on the mold cavity, with the hot runner system, or within the injection unit; 3. Dynamic adjustment of melt vibration using a local force generating unit.

While the present invention provides distinct advantages for injection-molded PET plastic preforms generally having circular cross-sectional shapes perpendicular to the preform axis, those skilled in the art will realize the invention is equally applicable to other molded products, possibly with non-circular cross-sectional shapes, such as, pails, paint cans, tote boxes, and other similar products. All such molded products come within the scope of the appended claims.

The individual components shown in outline or designated by blocks in the attached Drawings are all well-known in the injection molding arts, and their specific construction and operation are not critical to the operation or best mode for carrying out the invention.

While the present invention has been described with respect to what is presently considered to be the preferred embodiments, it is to be understood that the invention is not limited to the disclosed embodiments. To the contrary, the invention is intended to cover various modifications and equivalent arrangements included within the spirit and scope of the appended claims. The scope of the following claims is to be accorded the broadest interpretation so as to encompass all such modifications and equivalent structures and functions.

All U.S. and foreign patent documents discussed above (and particularly the applications discussed above in paragraph [0013]) are hereby incorporated by reference into the Detailed Description of the Preferred Embodiments

1. A method for generating vibration in melt within an injection mold, comprising the steps of:
activating at least one active material element intermittently to move at least one movable surface in said mold with respect to at least one fixed surface in said mold.

2. The method of claim 1, wherein said vibration is transmitted to melt within an injection mold cavity of said mold.

3. The method of claim 2, wherein said at least one fixed surface is a core plate in said mold, and said at least one movable surface is a mold core insert in said mold.

4. The method of claim 2, wherein said at least one fixed surface is a manifold plate in said mold, and said at least one movable surface is a mold cavity insert in said mold.

5. The method of claim 2, wherein said at least one fixed surface includes a core plate and a manifold plate and said at least one movable surface includes a mold core insert and a mold cavity insert.

6. The method of claim 1, wherein said vibration is transmitted to melt within a hot runner nozzle system of said mold.

7. The method of claim 6, wherein said fixed surface is a manifold, and said movable surface is a hot runner nozzle body.

8. The method of claim 1, wherein said vibration is transmitted to melt within a runner.

9. The method of claim 1, wherein said step of intermittent activating is carried out at variable frequencies.

10. Apparatus for oscillating melt in an injection mold, comprising:
at least one stable surface within said injection mold;
at least one movable surface within said injection mold;
at least one active material element affixed to each stable surface, and adjacent to each movable surface; and, in use a
control means for repeatedly energizing said at least one active material element, wherein said repeated energizing of said at least one active material element generates oscillation in said melt.

11. The apparatus of claim 10, wherein said vibration is transmitted to melt within an injection mold cavity.

12. The apparatus of claim 11, wherein said at least one stable surface is a core plate, and said at least one movable surface is a mold core insert.

13. The apparatus of claim 11, wherein said at least one stable surface is a manifold plate, and said at least one movable surface is a mold cavity insert.

14. The apparatus of claim 11, wherein said at least one stable surface includes a core plate and a manifold plate and said at least one movable surface includes a mold core insert and a mold cavity insert.

15. The apparatus of claim 10, wherein said vibration is transmitted to melt within a hot runner nozzle system.

16. The apparatus of claim 15, wherein said fixed surface is a manifold, and said movable surface is a hot runner nozzle body.

17. The apparatus of claim 10, wherein said control means further includes sensors for detecting whether melt is present in said injection molding machine.

18. Apparatus for vibrating melted plastic in a mold cavity, comprising:
a cavity mold portion adjacent a cavity plate;
a core mold portion adjacent a core plate;
a mold cavity formed between said cavity mold portion and said core mold portion;
at least one piezoceramic actuator disposed between one or both of (i) said core plate and said core mold portion, and (ii) said cavity plate and said cavity mold portion; and in use,
a controller connected to said at least one piezoceramic actuator.

19. The apparatus of claim 18, wherein said at least one piezoceramic actuator is disposed between said core plate and said core mold portion, and said controller in use, actuates said piezoceramic actuator to vibrate said core insert.

20. The apparatus of claim 18, wherein said at least one piezoceramic actuator is disposed between said cavity plate and said cavity mold portion, and said controller actuates said piezoceramic actuator to vibrate said cavity insert.

21. The apparatus of claim 18, wherein at least one piezoceramic actuator is disposed between said core plate and said core mold portion, and at least one piezoceramic actuator is disposed between said cavity plate and said cavity mold portion, and said controller actuates said piezoceramic actuator to vibrate both of the core insert and the cavity insert.

22. An apparatus for vibrating melted plastic in a hot runner nozzle system, comprising:
a hot runner nozzle body;
a manifold;
at least one piezoelectric element provided intermediate said hot runner nozzle body and said manifold; and in use,
a controller for energizing said piezoelectric element intermittently to create vibration in said melted plastic.
